(19) United States
(12) Patent Application Publication
(10) Pub. No.: US 2016/0060520 A1
(43) Pub. Date: Mar. 3, 2016

(54) SCAVENGERS FOR SULFUR SPECIES AND/OR PHOSPHORUS CONTAINING COMPOUNDS

(71) Applicant: BAKER HUGHES INCORPORATED, Houston, TX (US)

(72) Inventors: Vaithilingam Panchalingam, Friendswood, TX (US); Bradley G. Harrell, Pearland, TX (US)

(73) Assignee: BAKER HUGHES INCORPORATED, Houston, TX (US)

(21) Appl. No.: 14/476,438

(22) Filed: Sep. 3, 2014

(51) Int. Cl. C09K 15/28; C02F 1/68; C09K 15/20

(52) U.S. Cl. CPC C09K 15/28; C09K 15/20; C02F 1/68; C02F 2101/101

(57) ABSTRACT

A scavenger additive, treated system, and method of using the same may treat a system having at least one sulfur species and/or at least one phosphorous-containing compound. At least one scavenger compound may be circulated or added to the system and may include, but is not limited to, aminals, dibutylamine, and combinations thereof. The scavenger compound(s) may increase the amount of inactivated sulfur species and/or inactivated phosphorous-containing compounds.

### TECHNICAL FIELD

The present invention relates to inactivating at least one sulfur species and/or at least one phosphorous-containing compound within a system, and more specifically relates to scavenger additives, treated systems, and methods of using the same where at least one scavenger compound may be circulated within the system, such as aminals, dibutylamine, and combinations thereof.

### BACKGROUND

One of the most difficult problems in the field of corrosion inhibition is that of preventing and/or inhibiting corrosion in oxygenated aqueous systems, such as in water floods, cooling towers, drilling muds, air drilling, auto radiator systems, etc. Many corrosion inhibitors capable of performing in non-aqueous systems and/or non-oxygenated systems perform poorly in aqueous and/or oxygenated systems (i.e. aerobic systems).

Pyrophosphates are one non-limiting example of a type of corrosion inhibitor usable may be used as corrosion inhibitors in oxygenated systems to decrease the amount of sulfur species within the oxygenated system. Ethoxylated fatty alcohol may react with phosphorous pentasulfide to form O,O-disubstituted dithiophosphoric acid and pyrophosphates as described in U.S. Pat. No. 4,075,291, which is herein incorporated by reference in its entirety. The '291 patent sets forth the following reactions for obtaining the pyrophosphate products:

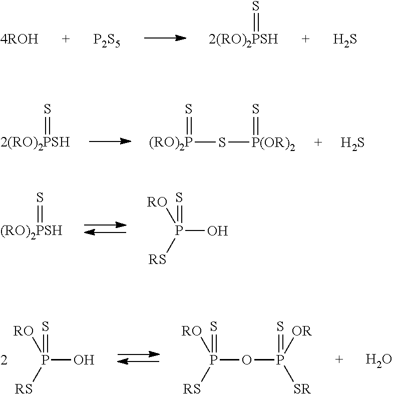

The O,O-disubstituted dithiophosphoric acid initially formed may proceed through an anhydride formation and/or an isomerization to yield the pyrophosphates as shown in the above reactions. The final reaction yields about 40% O,O-disubstituted dithiophosphoric acid as a final product and 60% pyrophosphates and anhydride products. Even though much of the hydrogen sulfide is removed from the initial reaction products, hydrogen sulfide may still form from the anhydride formation and/or isomerization of the O,O-disubstituted dithiophosphoric acid reaction, even after storage and handing of the resulting product. Thus, hydrogen sulfide may be released into the environment upon usage of the pyrophosphates as hydrogen sulfide scavengers.

After removing hydrogen sulfide from the initial reaction, hydrogen sulfide may be produced form the labile P—S—H linkage in the O,O-disubstituted dithiophosphoric acid. The water formed from the pyrophosphate reaction and/or moisture in the storage container, under normal handling conditions, may react with O,O-disubstituted dithiophosphoric acid to form additional hydrogen sulfide.

This additional hydrogen sulfide tends to form in the headspace of a storage container and has been difficult to remove prior to using the product (e.g. pyrophosphates).

It would be desirable if alternative corrosion inhibitors were devised that do not react with other components within a current system and/or are less toxic to the environment and less corrosive.

### SUMMARY

There is provided, in one form, a system having at least one phosphorous-containing compound and at least one scavenger compound. The phosphorous-containing compound may be or include O,O-disubstituted dithiophosphoric acid, pyrophosphates, and combinations thereof. The scavenger compound may be or include aminals, dialkylamine, and combinations thereof. The system may be or include an aqueous system, a non-aqueous system, an aerobic system, an anaerobic system, and combinations thereof.

In an alternative embodiment of the system, the system may include at least one sulfur species. The system may have at least one inactivated composition, such as at least one inactivated sulfur species, at least one inactivated phosphorous-containing compounds, and combinations thereof.

In another form, there is provided a method comprising circulating at least one scavenger compound within a system having at least one phosphorous-containing compound, such as O,O-disubstituted dithiophosphoric acid, pyrophosphates, and combinations thereof. The scavenger compound may be or include aminals, dibutylamine, and combinations thereof. The system may be or include an aqueous system, a non-aqueous system, an aerobic system, an anaerobic system, and combinations thereof.

In an alternative form of the method, the system may also include at least one sulfur species. The method may further include inactivating the phosphorous-containing compound(s), the sulfur specie(s), and combinations thereof.

The scavenger compounds are devised to react with the phosphorous containing compounds and the sulfur species and produce stable products within the current system.

### DETAILED DESCRIPTION

It has been discovered that the amount of hydrogen sulfide in a head-space of a container having pyrophosphates may increase during storage even after extended nitrogen purging of the container to remove excess hydrogen sulfide. A scavenger additive having at least one scavenger compound may be circulated within a system, such as the container or the headspace of the container in a few illustrative non-limiting embodiments, to decrease an amount of at least one sulfur species and/or at least one phosphorous-containing compound therein. The scavenger compound may inactivate at least a portion of the sulfur specie(s) and/or the phosphorous-containing compound(s). Inactivate is defined herein to mean that the sulfur species and/or phosphorous-containing compounds may be chemically altered to no longer chemically react with other components in the current system. The inactivated sulfur species and/or inactivated phosphorous-containing compounds are stable products.

In an alternative non-limiting embodiment, the scavenger additive may be added to a high temperature fluid system, such as an aqueous system, a non-aqueous system, an aerobic system, an anaerobic system, and combinations thereof. Non-limiting examples of the non-aqueous fluid may be or include hydrocarbon fluids formed during crude oil refining process, e.g. gas oils and/or light lubricating oils.

The scavenger additive may be added to the system, or to a feed to the system. The feed may be a stream that is merely heated to become the hot fluid or stream that is somehow treated or otherwise converted into the hot fluid or system, such as a feed to a distillation unit or a reactor, e.g. for refining of hydrocarbon feeds or streams.

That is, it is not necessary for the sulfur species and/or phosphorous containing compounds to be entirely inactivated for the methods, scavenger additives, and/or treated systems to be considered effective, although complete inactivation is a desirable goal. Success is obtained if more of the sulfur species and/or phosphorous-containing compounds are inactivated by adding or circulating the scavenger compound(s) into the system than in the absence of the scavenger compound(s). Alternatively, the methods described are considered successful if a majority of the sulfur species and/or phosphorous-containing compounds within the current system are inactivated. ‘Majority’ is defined herein to be an amount greater than about 50% of the sulfur species and/or the phosphorous-containing species within the current system.

A first scavenger compound may be or include, but is not limited to, aminals, dialkylamine, and combinations thereof. Two or more scavenger compounds may be circulated in the system at the same time or at different times. The scavenger compounds do not need to be added or circulated at the same time in the system to be considered effective. In a non-limiting embodiment, dialkylamine, dialkylamine-O—O-disubstituted dithiophosphoric acid salt, thioformaldehyde, and combinations thereof may be produced within the system as a product of a reaction to inactivate the sulfur species and/or phosphorous-containing compounds. The dialkylamine may have or include alkyl group that are straight or branched chain, and each alkyl group may have from 1 carbon to about 5 carbons, or from about 2 carbons to about 4 carbons.

The aminal may be a linear aminal, or a cyclic aminal, such as but not limited to tetrahydropyrimidine, hexahydropyrimidine, pyrophosphates, and combinations thereof. In a non-limiting embodiment, the cyclic aminal may be 5-tetrahydropyrimidine (5-THP) or another cyclic aminal that is formed by reacting a carbonyl compound (ketone or aldehyde) with ammonia, such as those described in U.S. Pat. No. 3,904,624, which is herein incorporated by reference in its entirety. A non-limiting example of the hexahydropyrimidine may be or include 2,2,4,4-dipentamethylene-5,6-tetramethylene hexahydropyrimidine, such as that described by U.S. Pat. No. 3,936,279, which is herein incorporated by reference in its entirety.

In addition to the cyclic aminal or other type of aminal, or in the alternative, the aminal may be or include, but is not limited to, the aminal may be or include (R1)(R2)N—CH₂—N(R3)(R4). R1-R4 may be an alkyl group, an aryl group, a substituted aryl group, an alkylalkoxylate, and combinations thereof in a non-limiting embodiment, and R1, R2, R3, and R4 may be the same or different. In a non-limiting example, the alkyl group may have from 1 carbon to 5 carbons, or from 2 carbons to 4 carbons, and the alkyl group may be a straight chain or a branched chain. Alternatively, R1-R4 of the aminal may be or include at least one butyl group; R1-R4 may be all butyl groups (e.g. (Bu)₂N—CH₂—N(Bu)₂), or only one R group of R1-R4 may be a butyl group.

Non-limiting combinations of the scavenger compounds may be or include (Bu)₂N—CH₂—N(Bu)₂, and dibutylamine, and combinations thereof; maleic anhydride and dibutylamine; maleic anhydride and (Bu)₂N—CH₂—N(Bu)₂, etc. Moreover, ‘first’ and ‘second’ with respect to the scavenger compounds are used as descriptors to distinguish between the scavenger compounds circulated within system; scavenger compounds noted as ‘first’ or ‘second’ scavenger compounds do not necessarily need to be circulated in the system in a particular order.

The system may have or include an increased amount of at least one inactivated sulfur species and/or inactivated phosphorous-containing compound as compared to an otherwise identical system absent the scavenger compound(s). The sulfur specie(s) may be or include mercaptans, sulfides (e.g. hydrogen sulfide), and combinations thereof in a non-limiting embodiment. In another non-limiting embodiment, the phosphorous-containing compound may be or include O,O-disubstituted dithiophosphoric acid, pyrophosphates, and combinations thereof.

The system may be an aqueous system, a non-aqueous system, an aerobic system (an oxygenated system), an anaerobic system, and combinations thereof. In a non-limiting embodiment, the aerobic system may be or include a water flood, a water-based or brine-based fluid for drilling or exploration, a refinery fluid, a cooling tower, air drilling, an auto radiator system, and combinations thereof. Non-limiting examples of the water-based or brine-based fluid may be or include drilling fluids, completion fluids, stimulation fluids, servicing fluids, and combinations thereof.

Drilling fluids are typically classified according to their base fluid. In water-based fluids, solid particles are suspended in a continuous phase consisting of water or brine. Oil can be emulsified in the water which is the continuous phase. “Aqueous-based fluid” is used herein to include fluids having an aqueous continuous phase where the aqueous continuous phase can be all water or brine, an oil-in-water emulsion, or an oil-in-brine emulsion. Brine-based fluids, of course are water-based fluids, in which the aqueous component is brine.

Non-aqueous-based fluids are the opposite or inverse of aqueous-based fluids. “Non-aqueous-based fluid” is used herein to include fluids having a non-aqueous continuous phase, such as II oil, a non-aqueous fluid, a water-in-oil emulsion, a water-in-non-aqueous emulsion, a brine-in-oil emulsion, or a brine-in-non-aqueous emulsion. In non-aqueous-based fluids, solid particles are suspended in a continuous phase consisting of oil or another non-aqueous fluid. Water or brine can be emulsified in the oil; therefore, the oil is the continuous phase. In non-aqueous-based fluids, the oil may consist of any oil or water-immiscible fluid that may include, but is not limited to, diesel, mineral oil, esters, refinery cuts and blends, or alpha-olefins. Non-aqueous-based fluid as defined herein may also include synthetic-based fluids or muds (SBMs), which are synthetically produced rather than refined from naturally-occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

Completion fluids may be placed in a well to facilitate final operations prior to initiation of production. Completion fluids are typically brines, such as chlorides, bromides, formates, but may be any non-damaging fluid having proper density and flow characteristics. Suitable salts for forming the brines include, but are not necessarily limited to, sodium chloride, calcium chloride, zinc chloride, potassium chloride, potassium bromide, sodium bromide, calcium bromide, zinc bromide, sodium formate, potassium formate, ammonium formate, cesium formate, and mixtures thereof.

Chemical compatibility of the completion fluid with the reservoir formation and fluids is key. Chemical additives, such as polymers and surfactants are known in the art for being introduced to the brines used in well servicing fluids for various reasons that include, but are not limited to, increasing viscosity, and increasing the density of the brine. Water-thickening polymers serve to increase the viscosity of the brines and thus retard the migration of the brines into the formation and lift drilled solids from the well-bore. Completion fluids also help place certain completion-related equipment, such as gravel packs, without damaging the producing subterranean formation zones. Conventional drilling fluids are rarely suitable for completion operations due to their solids content, pH, and ionic composition.

Servicing fluids, such as remediation fluids, workover fluids, and the like, have several functions and characteristics necessary for repairing a damaged well. Such fluids may be used for breaking emulsions already formed and for removing formation damage that may have occurred during the drilling, completion and/or production operations. The terms “remedial operations” and “remediate” are defined herein to include a lowering of the viscosity of gel damage and/or the partial or complete removal of damage of any type from a subterranean formation. Similarly, the term “remediation fluid” is defined herein to include any fluid that may be useful in remedial operations.

Before performing remedial operations, the production of the well must be stopped, as well as the pressure of the reservoir contained. To do this, any tubing-casing packers may be unseated, and then servicing fluids are run down the tubing-casing annulus and up the tubing string. These servicing fluids aid in balancing the pressure of the reservoir and prevent the influx of any reservoir fluids. The tubing may be removed from the well once the well pressure is under control. Tools typically used for remedial operations include wireline tools, packers, perforating guns, flow-rate sensors, electric logging sondes, etc.

Refinery fluids are fluids that may be further processed or refined at a refinery. A non-limiting example of a refinery process may include reducing or preventing the formation of foulants, such as sulfur species, inorganic solids, phosphorous-containing compounds, asphaltenes, coke, coke precursors, and the like. Non-limiting examples of refinery fluids include crude oil, production water, and combinations thereof.

In a non-limiting embodiment of a current system, a first reaction may occur between a first scavenger compound and at least one sulfur species to form a first reaction product. A second reaction may occur between the first reaction product and a phosphorous containing compound to form a stable second reaction product. The stable second reaction product may not further react within the system. In a non-limiting example of the first reaction and the second reaction, (Bu)₂N—CH₂—N(Bu)₂ may be circulated within the system and react with any hydrogen sulfide present within the current system. The first reaction products of this ‘first reaction’ may be thioformaldehyde and dibutylamine. The dibutylamine may react with O,O-disubstituted dithiophosphoric acid in a second reaction to produce a stable phosphorous-containing salt, which does not further release hydrogen sulfide, or does not further react within the current system. The phosphorous-containing salt is the ‘second reaction product’ for purposes of this example. ‘Current system’ is defined as a system having components therein at the time the scavenger compound(s) are circulated. Components added to the system after the formation of the stable phosphorous-containing salt would not be part of the current system.

Reactants ‘A’ and ‘E’ may form the product ‘stable salt’ where ‘stable salt’ is the stable phosphorous-containing salt according to the following reaction:

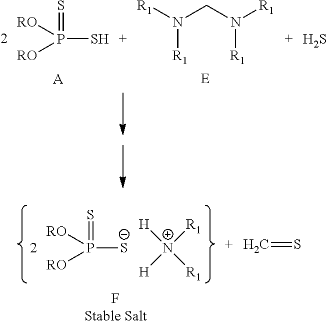

where: R as denoted in compound ‘A’ and compound ‘F’ may be or include CH₃(CH₂)ₘ(OCH₂CH₂)ₙ—, where m ranges from 5 to 9, and n ranges from 2 to 4, or more preferably; alternatively m ranges from 7 to 9, and n ranges from 3 to 4. H₂S may react with product ‘E’ to form the cation of the stable salt and H₂C═S. In a non-limiting embodiment, the H₂S may react with product ‘E’ at the CH₂ position between the two nitrogens in a non-limiting embodiment.

As used herein, ‘first reaction’, ‘first reaction product’, ‘second reaction’, and ‘second reaction product’ are used to distinguish between the two types of reactions and their corresponding reaction products. In some instances, the reactions will proceed in a sequential manner, such as that noted above. In another non-limiting instance, dialkylamine (e.g. dibutylamine) and (R1)₂N—CH₂—N(R1)₂ [e.g. (Bu)₂N—CH₂—N(Bu)₂] may be added and circulated in the system. Thus, the ‘second reaction’, i.e. where the dibutylamine targets the O,O disubstituted dithiophosphoric acid, may occur in the absence of the ‘first reaction’.

The amount of the scavenger compound(s) to be added to the system may range from about 1 wt % independently to about 15 wt % based on the total amount of the system, alternatively from about 5 wt % independently to about 12 wt %, or from about 8 wt % independently to about 10 wt % in another non-limiting embodiment. As used herein with respect to a range, “independently” means that any threshold may be used together with another threshold to give a suitable alternative range, e.g. about 1 wt % independently to about 5 wt % is also considered a suitable alternative range.

In a non-limiting embodiment, an amount of the (R₁)₂N—CH₂—N(R₁)₂ [e.g. (Bu)₂N—CH₂—N(Bu)₂] to be reacted with the O,O-disubstituted dithiophosphoric acid may be calculated by using the formula:

X=(0.0019)(acid number)(Y)

where X is the amount of (R₁)₂N—CH₂—N(R₁)₂ [e.g. (Bu)₂N—CH₂—N(Bu)₂] in grams and where Y is the amount of the O,O-disubstituted dithiophosphoric acid in grams. The (R₁)₂N—CH₂—N(R₁)₂ [e.g. (Bu)₂N—CH₂—N(Bu)₂] may target both the sulfur species and the phosphorous-containing compound, if both are present in a current system.

The mole ratio of (R₁)₂N—CH₂—N(R₁)₂ [e.g. (Bu)₂N—CH₂—N(Bu)₂] to the O,O-disubstituted dithiophosphoric acid may range from about 0.1:1 independently to about 0.5:1, or alternatively from about 0.3:1 independently to about 1:2. The mole ratio of (R₁)₂N—CH₂—N(R₁)₂ [e.g. (Bu)₂N—CH₂—N(Bu)₂] to the hydrogen sulfide may range from about 1:1 to about 2:1, or from about 2:1 independently to about 0.33:1 in a non-limiting embodiment. The acid number for the (R₁)₂N—CH₂—N(R₁)₂ [e.g. (Bu)₂N—CH₂—N(Bu)₂] treated product may range from about 40 independently to about 20, or from about 30 independently to about 1 in a non-limiting embodiment. The method may include circulating the scavenger compounds in the system and inactivating the sulfur specie(s) and/or the phosphorous-containing compounds within the system.

The effective amount of scavenger additive within the system may vary depending on the local conditions and the particular system being treated. The temperature and other characteristics of the system may have a bearing on the amount of the scavenger additive to be added thereto. The temperature of the system may range from about 0° C. independently to about 400° C., or from about 30° C. independently to about 300° C. in another non-limiting embodiment, or from about 50° C. independently to about 205° C.

The invention will be further described with respect to the following Examples, which are not meant to limit the invention, but rather to further illustrate the various embodiments.

### Example 1

The release of hydrogen sulfide from the headspace of a system was eliminated by adding a scavenger compound to the system where the system included O,O-disubstituted dithiophosphoric acid, pyrophosphates, and the like, and an acid number was 64 mg KOH/g of product. (R₁)₂N—CH₂—N(R₁)₂ [i.e. (Bu)₂N—CH₂—N(Bu)₂] was added to the system in an amount of 34 g per 209 g of O,O-disubstituted dithiophosphate and a pyrophosphates-containing corrosion inhibitor. The compound eliminated the hydrogen sulfide in the headspace, which had a volume of about 30% of the total volume of the container. ‘Head-space’ is defined herein as the unfilled space above the contents within a closed container. The scavenger compound also reacted with O,O-disubstituted dithiophosphoric acid to form a phosphorous-containing stable salt. One mole of the scavenger compound reacted with two moles of O,O-disubstituted dithiophosphoric acid to form the stable salt. In addition, one mole of the scavenger compound inactivated one mole of hydrogen sulfide within the current system. ‘Stable’ is defined herein to mean that the salt or reaction product does not further react within the current system, i.e. no additional hydrogen sulfide or other byproducts are generated from the stable salt or stable reaction product within the current system.

### Example 2

A C₈-C₁₀ fatty alcohol reacted with 3-4 moles of ethylene oxide (576 g: 2 mol) and was stirred at a temperature between about 25° C. to about 40° C., while P₂S₅ (111 g; 0.5 mol) was added over a period of 2 hours. The reaction was heated to a temperature between about 105° C. and 109° C. at a pressure of about 70 mmHg for about 9.5 hrs. Upon cooling the system, 657 g was obtained as a pale yellow liquid. The acid number was about 35 mg KOH/g for the product. This corresponds to a mixture of about 40% O,O-disubstituted dithiophosphoric acid and 60% of anhydrides and pyrophosphates. To 330 g of this product, 49 g of an aminal reaction product derived from 2 mol of dibutylamine and 1 mol of formaldehyde was added at 30° C. over a 0.5 hr period. The resulting system was sampled at regular time intervals with a Drager tube for hydrogen sulfide. No hydrogen sulfide was detected over a period of two months following the addition of the aminal reaction product.

### Example 3

Table 1 summarizes the results from additional examples where the efficiency of the aminal with three different corrosion inhibitor batches of 0,O-disubstituted dithiophosphoric acid and pyrophosphates in aromatic 100 solvent was measured. The first two sets measured the amount of H₂S levels for each sample within both sets after 2 months. The third set measured the amount of H2S levels for each sample within set 3 after 6 days. Sets 1 and 2 were left at ambient temperature during the two month period, while the temperature for the samples within Set 3 was 40° C. The increased temperature within Set 3 may have accelerated the release of any H₂S release remaining within the headspace. Although not shown in Table 1, there is no detectable H₂S within the headspace for Set 3 after one month at 40° C. As noted from Table 1, an increased amount of aminal added to the head space decreases the amount of H₂S within the headspace. In addition, increasing the temperature during the reaction and possibly after the reaction may decrease the amount of H₂S within the headspace.

TABLE 1
Measurements of H₂S Within the Headspace

| | | Acid | | | | |
|---|---|---|---|---|---|---|
| | | Number for | Amount of | | Aromatic | Head |
| | | Corrosion | Corrosion | Amount of | 100 | Space |
| | | Inhibitor | Inhibitor | Aminal | Solvent | H₂S, |
| Sample | Temperature | (mg KOH/g) | (Wt. %) | (Wt. %) | (Wt. %) | ppm |
| | Set 1: Observation after 2 months | | | | | |
| 1A | Ambient | 42.58 | 53.5 | 0 | 46.5 | 17,000 |
| 1B | Ambient | 42.58 | 53.5 | 3.75 | 42.75 | 0.55 |
| 1C | Ambient | 42.58 | 53.5 | 7.5 | 39 | ND |
| | Set 2: Observation after 2 months | | | | | |
| 2A | Ambient | 63.38 | 53.5 | 0 | 46.5 | 68,000 |
| 2B | Ambient | 63.38 | 53.5 | 7.5 | 39 | 0.1 |
| 2C | Ambient | 63.38 | 53.5 | 8.5 | 38 | ND |
| | Set 3: Observation after 6 Days | | | | | |
| 3A | 40° C. | 44.78 | 53.5 | 0 | 46.5 | 23,000 |
| 3B | 40° C. | 44.78 | 53.5 | 3.75 | 42.75 | 0.1 |
| 3C | 40° C. | 44.78 | 53.5 | 5 | 41.5 | ND |

*ND (Not detected)

In the foregoing specification, the invention has been described with reference to specific embodiments thereof, and has been described as effective in providing compositions and methods for scavenging phosphorous containing compounds and/or sulfur species within a current system. However, it will be evident that various modifications and changes can be made thereto without departing from the broader spirit or scope of the invention as set forth in the appended claims. Accordingly, the specification is to be regarded in an illustrative rather than a restrictive sense. For example, specific systems, phosphorous containing compounds, sulfur species, scavenger compounds, and functional groups within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the treated system may consist of or consist essentially of at least one phosphorous-containing compound and at least one scavenger compound; the phosphorous-containing compound may be or include O,O-disubstituted dithiophosphoric acid, pyrophosphates, and combinations thereof; the scavenger compound may be or include aminals, dialkylamine, and combinations thereof; the system may be or include an aqueous system, a non-aqueous system, an aerobic system, an anaerobic system, and combinations thereof.

The method may consist of or consist essentially of a system having at least one phosphorous-containing compound and at least one scavenger compound; the phosphorous-containing compound may be or include O,O-disubstituted dithiophosphoric acid, pyrophosphates, and combinations thereof; the scavenger compound may be or include aminals, dialkylamine, and combinations thereof; and the system may be or include an aqueous system, a non-aqueous system, an aerobic system, an anaerobic system, and combinations thereof.

The words “comprising” and “comprises” as used throughout the claims, are to be interpreted to mean “including but not limited to” and “includes but not limited to”, respectively.

What is claimed is:

1. A treated system comprising:
a system selected from the group consisting of an aqueous system, a non-aqueous system, an aerobic system, an anaerobic system, and combinations thereof; and wherein the system comprises at least one phosphorous-containing compound selected from the group consisting of O,O-disubstituted dithiophosphoric acid, pyrophosphates, and combinations thereof; and
at least one scavenger compound selected from the group consisting of aminals, dialkylamine, and combinations thereof.

2. The treated system of claim 1, wherein the aminal is (R1)(R2)N—CH₂—N(R3)(R4) where R1-R4 may be an alkyl group, an aryl group, a substituted aryl group, an alkylalkoxylate, and combinations thereof; and wherein R1, R2, R3, and R4 may be the same or different.

3. The treated system of claim 1, wherein the amount of the at least one scavenger compound present in the treated system ranges from about 1 wt % to about 15 wt % based on the total amount of the system.

4. The treated system of claim 1, wherein the treated system further comprises at least one sulfur species.

5. The treated system of claim 4, further comprising a first reaction product produced from a first reaction between the at least one scavenger compound and the at least one sulfur species.

6. The treated system of claim 1, further comprising a second reaction product produced from a second reaction between a first reaction product and the at least one phosphorous containing compound.

7. The treated system of claim 6, wherein the second reaction product is a stable reaction product.

8. A treated system comprising:
a system selected from the group consisting of an aqueous system, a non-aqueous system, an aerobic system, an anaerobic system, and combinations thereof; and wherein the system comprises at least one sulfur species and at least one phosphorous-containing compound selected from the group consisting of O,O-disubstituted dithiophosphoric acid, pyrophosphates, and combinations thereof;
at least one scavenger compound selected from the group consisting of aminals, dialkylamine, and combinations thereof; and
at least one inactivated composition selected from the group consisting of at least one inactivated sulfur species, at least one inactivated phosphorous-containing compounds, and combinations thereof.

9. A method comprising:
circulating at least one scavenger compound within a system comprising at least one phosphorous-containing compound selected from the group consisting of O,O-disubstituted dithiophosphoric acid, pyrophosphates, and combinations thereof; wherein the system is selected from the group consisting of an aqueous system, a non-aqueous system, an aerobic system, an anaerobic system, and combinations thereof; wherein the at least one scavenger compound is selected from the group consisting of aminals, dialkylamine, and combinations thereof.

10. The method of claim 9, wherein the aminal is (R1)(R2)N—CH₂—N(R3)(R4) where R1-R4 may be an alkyl group, an aryl group, a substituted aryl group, an alkylalkoxylate, and combinations thereof; and wherein R1, R2, R3, and R4 may be the same or different.

11. The method of claim 10, wherein aminal R1-R4 group is selected from the group consisting of an alkyl group, an aryl group, a substituted aryl group, an alkylalkoxylate, and combinations thereof; and wherein R1, R2, R3, and R4 are the same or different.

12. The method of claim 9, wherein the dialkylamine comprises an alkyl group that is a straight or branched chain having from 1 carbon to 5 carbons.

13. The method of claim 9, further comprising adding the at least one scavenger compound to the system prior to circulating the at least one scavenger compound.

14. The method of claim 9, wherein the amount of the at least one scavenger compound circulated in the system ranges from about 1 wt % to about 15 wt % based on the total amount of the system.

15. The method of claim 9, further comprising inactivating the at least one phosphorous-containing compound within the system to form at least one inactivated phosphorous-containing compound.

16. The method of claim 9, wherein the system further comprises at least one sulfur species.

17. The method of claim 16, further comprising reacting the at least one scavenger compound with the at least one sulfur species to form a first reaction product.

18. The method of claim 9, further comprising reacting a first reaction product with the at least one phosphorous-containing compound to form a second reaction product; and wherein the second reaction product is a stable reaction product.

19. A method comprising:
circulating at least one scavenger compound within a system comprising at least one sulfur species and at least one phosphorous-containing compound selected from the group consisting of O,O-disubstituted dithiophosphoric acid, pyrophosphates, and combinations thereof; wherein the system is selected from the group consisting of an aqueous system, a non-aqueous system, an aerobic system, an anaerobic system, and combinations thereof; wherein the at least one scavenger compound is selected from the group consisting of aminals, dialkylamine, and combinations thereof; and
inactivating the at least one phosphorous-containing compound, the at least one sulfur species, and combinations thereof.
